(19) United States
(12) Patent Application Publication
(10) Pub. No.: US 2007/0017158 A1
(43) Pub. Date: Jan. 25, 2007

(54) Door shielding system against domestic animal scratching

(76) Inventors: Kevin B. Larkin, Pebble Beach, CA (US); Deborah L. Larkin, Pebble Beach, CA (US)

Correspondence Address: JOHANNES SCHNEEBERGER, 118B MENDOCINO ST., BRISBANE, CA, 94005, US

(21) Appl. No.: 11/185,234

(22) Filed: Jul. 19, 2005

(51) Int. Cl. E05B 1/00

(52) U.S. Cl. 49/460

(57) ABSTRACT

A door scratch shield and an optional frame scratch shield are configured for protecting a door and optionally its frame against push, pull and handle scratching as forms of escape scratching performed by domestic animals. The shield elements have bends that protect lateral sides of door and frame against pull scratching predominantly along the door's opening edge. The shield elements are of a material and thickness defined in conjunction with identified strength, hardness and approximated tip radius of domestic animal claws.

### FIELD OF INVENTION

The present invention relates to door shielding devices that protect against door scratching caused by domestic animals.

### BACKGROUND OF INVENTION

A common problem in keeping domestic animals is their tendency to scratch at doors either to signal a desire, or in the case of cats sharpening their claws, or attempting to escape by overcoming the door as a barrier. To protect a door against escape scratching of a domestic animal requires measures quite different than those to deal with signal scratching or claw sharpening. Varying techniques developed by individual domestic animals may result in varying scratching habits practiced by animals during escape scratching. A particularity of escape scratching is that the animal may search for the best scratch spot that fits its anatomy and that may depend also on the configuration of the affected door.

For example, in case of a door having a lever type door handle, escape scratching may particularly occur on the door face in the vicinity and below the door handle. Both cats and dogs eventually recognize the lowering of the door handle as a prerequisite for the door to open. A cat may jump up and cling on the lever type door handle and pull it down with its own weight. A dog may stand up on its rear legs and pull down the lever handle with its front legs. Even in cases of knob type door handles, the animal may attempt to actuate, it resulting in even severer scratch damage of the unprotected door face in the vicinity of the knob handle.

In another form of escape scratching, the animal attempts to open a door that swings open towards the animal. In such a case, the animal may perform a pull scratching during which it reaches into the gap between the door frame and the opening edge of the door and scratches along the opening edge of the door while attempting to pull the door towards itself. The area along the opening edge of the door is thereby particularly exposed to scratch damage. The door frame along the opening edge may also be affected by escape scratching and may need to be shielded.

Also a form of escape scratching occurs when the animal attempts to open a door that opens away from the animal. In that case, the animal may perform a push type scratching predominantly on the face of the door and/or along the opening edge of the door. Dogs may be also be driven by their sense of smell to determine a scratch location, which may be beneath the bottom of the closed door. There a scent may propagate from the other side of the closed door. As can be seen from all these examples, to shield a door against escape scratching may require a specifically configured shielding device or system to accommodate for the multitude of door configurations and scratch patterns. The present invention addresses this need.

Domestic animals may escape scratch quite vigorously and persistent in an attempt to overcome the door. Considerable surface loads may be exerted thereby by the animal's claws that may be limited by the claws' strength. Therefore, there exists a need for identifying the claws' material strength and to provide a protective shield of a material substantially stronger than claws. The present invention addresses these needs.

A further consideration for a door shielding system against escape scratching is easy installation and removal. The present invention addresses also this need.

### SUMMARY

A door shielding system includes at least a door scratch shield and an optional frame scratch shield to protect areas of a door susceptible to escape scratching of domestic animals. The door scratch shield has an area and a contour for covering at least one of an edge scratch area, a door handle scratch area and a bottom scratch area of a door. The frame scratch shield has an L-profile for covering the edge scratch area of a door frame preferably along the opening edge of the door. The door scratch shield and the eventual frame scratch shield are of a material having a surface hardness greater than the claws. The shield(s) may have a top edge height above an animal specific reach height.

The door scratch shield may also feature a bend on a vertical edge in direction of the door scratch shield's back for overlapping and protecting the door's edge and side face along its opening edge against pull scratching. The bend may be a U-shaped bend fully encapsulating the door's opening side and providing a form fitting connection with the door. An elastic layer may on the back side of the shield elements may serve as a buffer contact for a snug contact between shield element and door and/or frame front. The elastic layer may also serve as an adhesive for easily affixing the shield elements at their assembly location.

### BRIEF DESCRIPTION OF THE FIGURES

FIG. 1 is a perspective view of a door with schematically outlined scratch areas susceptible to escape scratching.

FIG. 2 is a front view of a door with a door scratch shield having a low top edge.

FIG. AA is a cross section view of FIG. 2 cut along a section line AA.

FIG. 3 is a front view of a door with a door scratch shield and a frame scratch shield having a high top edge.

FIG. BB is a detail cross section view of FIG. 3 cut along section line BB.

FIG. 4 is a front view of a door with a frame scratch shield and a door scratch shield having an optimized top edge.

FIG. CC is a detail cross section view of FIG. 4 cut along section line CC.

FIG. 5 is a front view of two closed sliding doors with door scratch shields each having an optimized top edge.

FIG. DD is a detail cross section view of FIG. 5 cut along section line DD.

FIG. 6 is a perspective view of the door scratch shield of FIG. 5.

FIG. 7 is a perspective view of the frame scratch shield of FIGS. 3 and 4.

FIG. 8 is a schematic depiction of an indentation pressure resulting from a domestic animal claw scratching along an assembled shield element.

### DETAILED DESCRIPTION

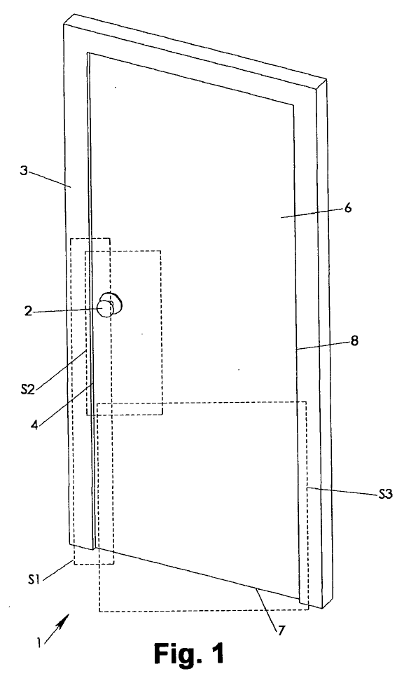

As in FIG. 1, a door 1 may have a scratching exposed face 6, a handle 2 for manually opening and closing the door 1 and an opening edge 4 commonly at the side of the handle 2. For the purpose of this invention, the opening edge 4 is defined as the edge of the door 1 that swings or slides open during opening of the door 1. The door 1 shuts within the door frame 3. Scratch areas primarily susceptible to escape scratching of domestic animals are an edge scratch area S1 in the vicinity of the opening edge 4 of the closed door 1, a handle scratch area S2 in the vicinity and below the door handle 2, and a bottom scratch area S3 along and above the bottom edge 7 of the door face 6.

In the context of the present invention, escape scratching may be distinguished from signal scratching and claw sharpening as a willful action of the domestic animal against the owners will to overcome the closed door 1 and/or its baring effect experienced by the domestic animal. Escape scratching may be subclassified into pull scratching along the opening edge 4, the bottom edge 7 and/or within the edge scratching area S1, handle scratching on the door handle 2 and within the scratch area S2, and push scratching along the bottom scratch area S3 and eventually within edge scratch area S1. Pull scratching may be defined as a scratching along side faces of the door 1 for opening the door towards the scratching animal. Handle scratching may be defined as a scratching occurring during the animals attempt to actuate the door handle 2. Push scratching may be defined as a scratching on the door face 1 and eventually the face of the frame 3 during the animal's attempt to open the door 1 in direction away from the scratching animal.

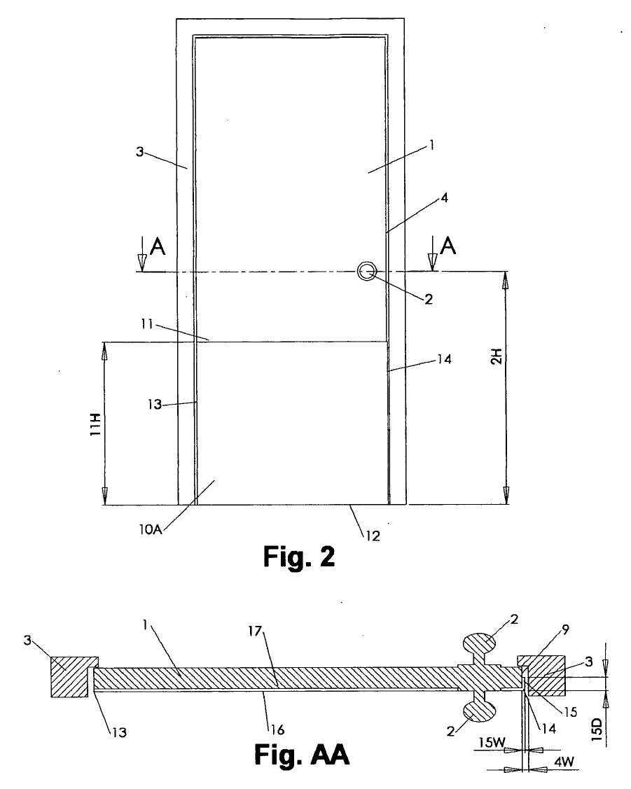

As shown in FIGS. 2 and AA, a door scratch shield 10A of a first embodiment of the invention has a shield front 16 facing away from the door 1 and a shield back 17 facing the towards the door 1. The boundary of the shield front 16 is defined by top edge 11, a bottom edge 12, a pivot side edge 13 and an opening side edge 14. The bottom edge 12 is preferably flush with the door's 1 bottom edge 7. The pivot side edge 13 is optionally flush with the door's 1 pivot edge 8.

Along the opening side edge 14 may extend an opening edge bend 15 along an opening side face 9 of the door 1. The edge bend 15 may have a width 15W sufficiently small to fit within the gap 4W between the side face 9 and the frame 3. The opening edge bend 15 may also have a bend depth 15D larger than a domestic animal's claw reach. The claw reach may be as much as the animal's claw length. The opening edge bend 15 is of particular value in protecting the door side face 9 against pull scratching and also in preventing a ripping of the door shield 10A off the door face 6 along the shield's 10A opening side edge 14. Even though pull scratching may occur predominantly along the opening edge 4, it may also occur along the bottom edge 7 and even along the pivot edge 8. For that purpose, a bend similar to the bend 15 may also extend along the bottom shield edge 12 and the pivot side edge 13 of the door shield 10A. In case of a solely employed door scratch shield 10A-E, door shield bend width 15W is sufficiently smaller than the gap 4W to warrant unimpeded opening and closing of the door 1. The door shield 10A-E may be accordingly dimensioned with its edges 11-14 and bend width 15W in conjunction with well known dimensional standards for domestic doors.

The top shield edge 11 may have a height 11H selected in combination with the domestic animals vertical reach in case of a dog, the vertical reach may be the reach of the front claws while the dog is standing on its rear paws. In case of a cat, the vertical reach may be the vertical distance a cat may jump up along the door.

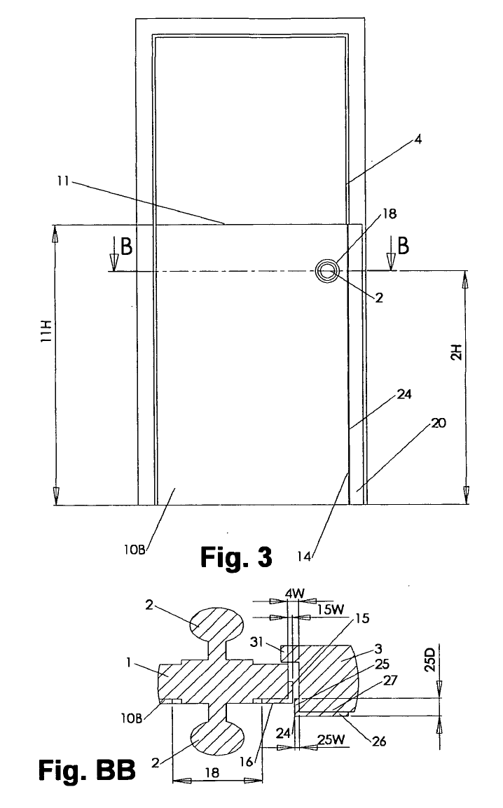

As depicted in FIGS. 3 and BB, the animal's vertical reach may extend up to and above the handle height 2H, in case of which the door scratch shield 10B may feature a handle cutout 18. An optionally employed frame scratch shield 20 may also feature a frame shield front 26 facing away from the frame 3 and a frame shield back 27 facing towards the frame 3. The frame scratch shield 20 may also feature a frame shield bend 25 extending into the gap 4W along the frame edge 24. The frame shield bend 25 has a utility as described for the edge bend 15 and may have a depth 25D sufficiently to extend beyond the door shield front 16 in assembled position and while the door 1 is shut. In case of an additionally employed frame scratch shield 20, door shield bend width 15W and frame shield bend width 25W are together sufficiently smaller than the gap 4W to warrant unimpeded opening and closing of the door 1. The frame shield 20 may be accordingly dimensioned in conjunction with well known dimensional standards for domestic door frames.

Door scratch shields 10A, 10B are depicted as assembled on the pull opening side of the door 1 that opens towards the scratch affected face 6, with the bends 15 being a monolithic part of the door scratch shields 10A, 10B. As described above, pull scratching may more likely occur on the pull opening side of the door 1. In case of the scratch affected door face 6 being on the side of the door that opens in direction away from the scratch affected door face 6, the gap 4W and the door side face 9 may be covered by a frame shoulder 5. In that case and as depicted in FIG. CC, a door scratch shield 10D may have a recessed opening edge 14A, which is recessed sufficiently in conjunction with the frame shoulder's 5 overlap. The frame shield 20 may be overlap with its bend 25 the recessed opening edge 14A and covering it against potential escape, which may likely be push scratching on the push opening sides of the door 1 more likely push scratching may occur

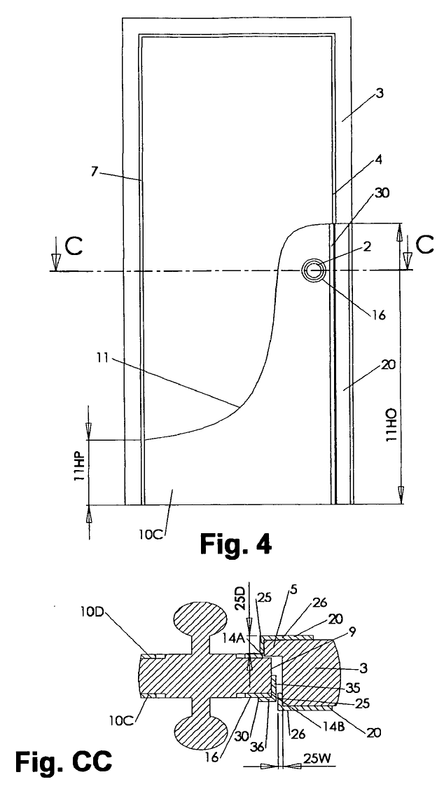

Further depicted in the FIGS. 4 and FIG. CC is an embodiment, in which a door scratch shield 10C has a dual configuration with a substantially planar portion providing scratch shielding of the area within the edges 11-14B and an edge profile 30 providing the bend 35 similar to the bend 15 and having a support front 36 combined with or affixed at the shield front 16.

The edge 14B may be flush with the door side face 9, or may be recessed like recessed edge 14A. In case of the edge 14B being similarly recessed as edge 14A, a modular shield system may be provided with a standardized planar front shield portion fitting both pull and push opening sides of the door 1 in combination with the edge profile 30 which may be either factory assembled or configured for a simultaneous on-site assembly on the shield front 16 and the door side face 9. The frame scratch shield 20 may be configured such that the bend width 25W and bend depth 25D comply with the dimensional frame standards and dimensional assembly requirement of both pull and push opening sides as depicted in FIG. CC. Also as shown in FIG. 4, the top edge 11 may have an optimized contour with an extended height 11HO in the vicinity of the handle 2 and a reduced height 11HP in the vicinity of the pivot edge 7 such that all three scratch areas S1, S2, S3 are sufficiently shielded with a minimum of shield material.

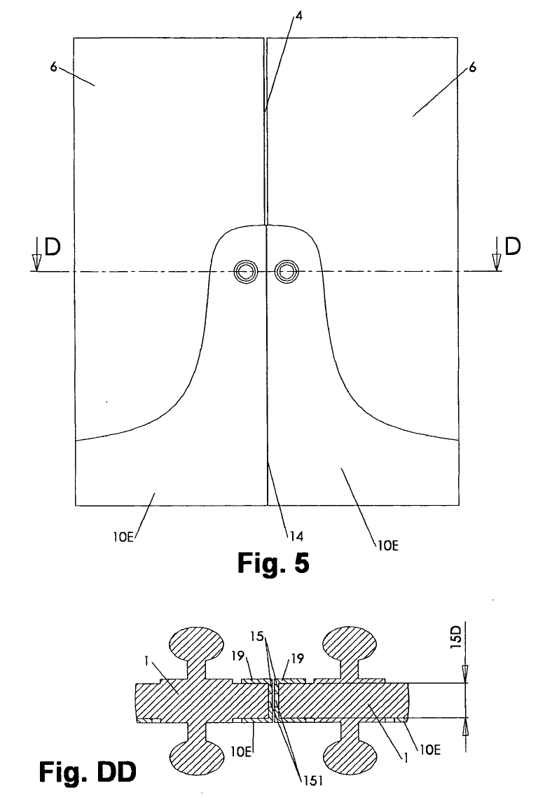

In FIGS. 5 and DD, a door scratch shield 10E may feature a U-bend 19 extending from the distal end of the bend 15 placed along the opening side edge 14 such that the opening door side 9 may be fully encapsulated. In that case, the bend depth 15D may be selected in conjunction with well known dimensional standards for the domestic door 1. The edge encapsulating U-bend 19 provides a form fitting and most reliable connection with the door 1 along the edge scratching area S1. The door scratch shield 10E may be employed in cases where the opening door edge 4 of a closed door 1 is not laterally contacting a door frame shoulder 5 as in the case of a sliding door. In case of a top edge height 11H, 11HO extending the handle height 2H, a latch cutout 151 may be part of the edge bend 15. The edge profile 30 may likewise feature a U-bend 19.

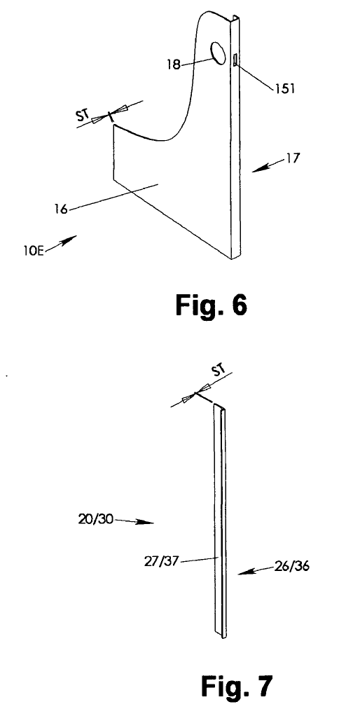

FIGS. 6 and7 show door scratch shield 10E and frame shield/edge profile 20/30 as representative elements of the door scratch shield system of the present invention. The system elements 10/20/30 are preferably monolithically fabricated. A design criterion identified and addressed in the present invention is a surface hardness of scratch affected element surfaces. The scratch affected surfaces may be at least the scratching exposed fronts 16/26/36 but also the outer faces of the bends 15/25/35. The surface hardness is greater than a hardness of domestic animal claws to prevent scratch abrasion. Domestic animal claws are of an organic composition similar to horn material of cow and horse hoofs, the mechanical properties of which are recently known. A maximum strength of about 30 N/mm**2 and a maximum modulus of elasticity of about 720 N/mm**2 well known for cow and horse hoof horn may be applied as reference values to determine the hardness of domestic animal claws as may be well appreciated by anyone skilled in the art.

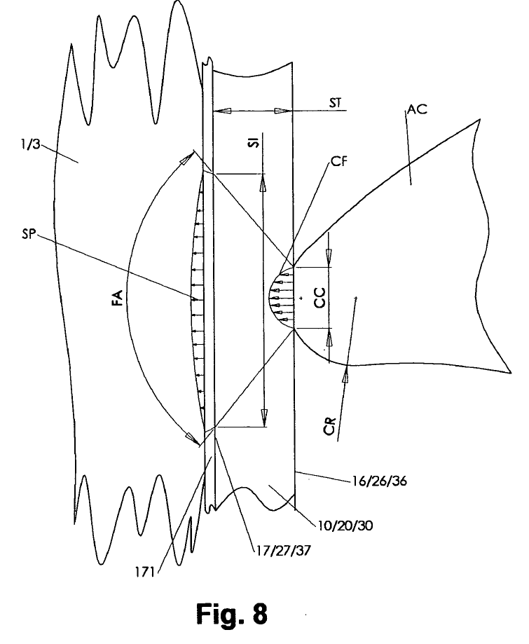

Referring to FIG. 8, a further design criterion identified and addressed in the present invention may be an indentation resistance of the scratch shielding elements 10/20/30, which may be mainly defined by the shield elements 10/20/30 shield thickness ST, shield material strength and shield material modulus of elasticity as may be well appreciated by anyone skilled in the art. The modulus of elasticity in turn defines a force fan-out angle FA from the claw contact area CC across the shield's 10/20/30 core, which may result in a shield-door interface area SI directly proportional with the shield thickness ST.

For a given claw force CF, shield material strength and eventual support condition on the shield back faces 17/27/37 define a first minimum calculation thickness sufficient to prevent destruction of the shield element 10/20/30 from a maximum claw force CF. Since the shield thickness ST directly affects the shield-door interface area SI for a given force fan-out angle FA, a maximum permissible shield pressure SP in the shield-door interface SI may define a second minimum calculation thickness sufficient for the shield pressure SP to remain within a predetermined limit for a given shield material composition and a given maximum claw force CF. The shield thickness ST may at least be equal to the greater of the first and second minimum calculation thickness.

An elastic layer 171 may be present on the back sides 17/27 to level shield pressure SP peaks as may be well appreciated by anyone skilled in the art. The elastic layer 171 may simultaneously provide adhesive contact for easily affixing the shield elements 10/20 on the door 1 and/or frame 3.

Claw force CF may vary dependent on the domestic animal. A method identified in the present invention for determining maximum claw force CF utilizes an approximated claw tip radius CR in conjunction with the maximum claw material strength, maximum stiffness of the claw material, shield strength and shield stiffness as may be well appreciated by anyone skilled in the art. Stiffness may be expressed by the respective modules of elasticity as is well known in the art.

The claw tip radius CR may reflect the animal's physical size and weight as well as is its general scratching behavior. This assumption follows the observation that claw tips tend to adjust to the animals behavior for the given claw material strength such that they remain intact irrespective the animals behavior. Unused claw tips tend to be more pointed with a smaller claw tip radius CR and vice versa, which may correspond to a variation of claw force CF. It also valid to assume, that the animal may keep its scratching force CF within a limit so as to not hurt its own claws AC. Therefore, taking the claws' AC material strength and tip configuration may serve well to approximate the maximum claw force CF. A scratch shield 10A was accordingly fabricated from Acrylic with a shield thickness ST of about between 0.01-0.035 inches. The shield 10A was affixed on a door 1 by means of a double back tape with the shield side being permanent and the door side being semi permanent so that the shield 10A may be removed without any tape remaining at the door face 6.

Accordingly, the invention described in the specification above is set forth by the following claims and their legal equivalent:

What is claimed is:

1) A door scratch shield for protecting a door against escape scratching of a domestic animal, said door scratch shield comprising:
a) an area and contour for covering at least one of an edge scratch area, a door handle scratch area and a bottom scratch area of a door; and
b) a shield front having a surface hardness greater than a hardness of domestic animal claws.

2) The door scratch shield of claim 1, further comprising a top edge height above an animal specific reach height.

3) The door scratch shield of claim 1, being a monolithic structure.

4) The door scratch shield of claim 1, further comprising a vertical opening edge having a bend in direction of a backside of said door scratch shield.

5) The door scratch shield of claim 4, further comprising a U-bend along a distal end of said bend for a form fitting encapsulation of an opening edge of said door.

6) The door scratch shield of claim 4 wherein said bend is provided by an angle profile combined with said door scratch shield.

7) The door scratch shield of claim 1 being fabricated from Acrylic.

8) The door scratch shield of claim 1, further comprising an elastic layer on a back side of said door scratch shield.

9) The door scratch shield of claim 1, wherein said elastic layer provides adhesive contact for affixing said door scratch shield.

10) A door scratch shield system for protecting a door against escape scratching of a domestic animal, said door scratch shield system comprising:
a) a door scratch shield;
b) a frame scratch shield; and
wherein said door scratch shield and said frame scratch shield have a surface hardness greater than horn material of domestic animal claws.

11) The door scratch shield system of claim 10, wherein said door scratch shield and said frame scratch shield comprise a top edge height above an animal specific reach height.

12) The door scratch shield system of claim 10, wherein at least one of said door scratch shield and said frame scratch shield is a monolithic structure.

13) The door scratch shield system of claim 10, wherein at least one of said door scratch shield and said frame scratch shield comprises a vertical edge having a bend.

14) The door scratch shield system of claim 13, further comprising a U-bend along a distal end of said bend for a form fitting encapsulation of an opening edge of said door.

15) The door scratch shield system of claim 13 wherein said bend is of said door scratch shield and provided by an angle profile combined with said door scratch shield.

16) The door scratch shield system of claim 12, wherein at least one of said door scratch shield and said frame scratch shield is fabricated from Acrylic.

17) The door scratch shield system of claim 12, wherein at least one of said door scratch shield and said frame scratch shield further comprises an elastic layer on a back side of said at least one of said door scratch shield and said frame scratch shield.

18) The door scratch shield system of claim 17, wherein said elastic layer provides adhesive contact for affixing at least one of said door scratch shield and said frame scratch shield.

19) A door comprising at least one of:
a) a door scratch shield attached to said door;
b) a frame scratch shield attached to a door frame of said door; and
wherein said door scratch shield and said frame scratch shield have a surface hardness greater than horn material of domestic animal claws.

20) The door of claim 19, wherein said door scratch shield and said frame scratch shield comprise a top edge height above an animal specific reach height.

21) The door of claim 19, wherein said door scratch shield and said frame scratch shield comprise an indentation resistance greater than an animal specific claw pressure.
